(19) United States
(12) Patent Application Publication
(10) Pub. No.: US 2015/0075539 A1
(43) Pub. Date: Mar. 19, 2015

(54) Child Seat Device for a Child and Stroller

(71) Applicant: Zimmer MedizinSysteme GmbH, Neu-Ulm (DE)

(72) Inventor: Valentyn Serdyuk, Odessa (UA)

(73) Assignee: Zimmer MedizinSysteme GmbH, Neu-Ulm (DE)

(21) Appl. No.: 14/367,609

(22) PCT Filed: Dec. 19, 2012
(86) PCT No.: PCT/EP2012/076120

§ 371 Date: Jun. 20, 2014

(30) Foreign Application Priority Data
Dec. 20, 2011 (DE) 102011089192.7

(51) Int. Cl. A61G 5/10; B62B 9/10; B62B 7/00; B60N 2/26; B60N 2/24

(52) U.S. Cl. CPC A61G 5/10; B60N 2/26; B60N 2/245; B62B 7/006; B62B 9/102; A61G 2005/122
USPC 128/845

(57) ABSTRACT

The invention relates to a child seat device for a child for aligning the spinal column of the child and for preventing and treating a spinal column curvature of the child (scoliosis), comprising an upper seat part and a lower seat part, wherein the upper seat part is provided with a supporting element on both sides, which supporting elements are designed and arranged relative to the upper seat part in such a way that, when a child is sitting on the child seat, the supporting elements surround the upper body of the child at the armpit level and thus limit lateral movements of the child, and wherein the child seat device is part of a child car seat or stroller.

### FIELD OF THE INVENTION

The present invention relates to a child seat device for a child for aligning the spinal column of the child and for preventing and treating a spinal column curvature (scoliosis) of the child. The child seat device can be attached to further items such as, for example, a car seat etc, for transportation of a child, for example, in a vehicle. The present invention also relates to a stroller or children's pushchair.

### TECHNICAL BACKGROUND

Strollers are generally known, which means that their structure and manner of operation does not need to be discussed in detail. A stroller is an aid to transporting babies and infants in a lying or sitting position. In some strollers the cradle part can be released from the frame and in some cases also used as a child car seat.

A child seat, also called a restraining device, is a seating arrangement adapted to the small body size of children. In particular, it usually refers to a seat for secure transportation of children in vehicles, which has an attachment system for the seat and restraining systems for the child or which at least raises the sitting position of the child so that the vehicle's seat belt provided for the sitting location does not extend across the throat but over the shoulder.

The human spinal column forms a number of arcs which are disposed with respect to each other and therefore balance one another out in order to keep the body in equilibrium. In the sagittal plane, the spinal column forms four physiological curves; cervical lordosis, thoracic kyphosis, lumbar lordosis and sacral kyphosis. Deviations of the spinal column in the frontal plane to the right or left are designated as scoliosis. Until a child begins to walk a (certain degree of) scoliosis is considered to be physiological and is designated as scoliotic posture. However, later the musculature is no longer able to compensate for the scoliotic deformation caused by a simultaneous rotation of the vertebrae and the subsequent underdevelopment of the vertebral body, arches and ligaments, and it therefore becomes an abnormality.

Scolioses are classified according to their cause and the time of onset, according to the position of curves and pattern of curvature involved, according to their degree (angles of curvature and degrees of rotation) and the orientation of the curves (left, right). It has proved to be the case that scoliosis appears and worsens in childhood and at times of rapid growth in body length. The more rapid the growth of the body, the more quickly the curves increase. Scolioses are consequently classed as growth deformities.

Scolioses are currently treated by the insertion of an implant or by the wearing of an orthopaedic brace. However, the insertion of an implant is a considerable surgical intervention, which means that it is not suitable for infants. The wearing of an orthopaedic brace is not a suitable way of treating scoliosis in infants. In this respect these currently known means for treating scolioses are restricted to use on adults or older children. In the case of infants there are currently no suitable means for treating scolioses although the risk of scoliosis occurring is at its greatest in the case of these infants because of their very rapid growth rate.

This is a situation ripe for improvement.

### SUMMARY OF THE INVENTION

On the basis of this background it is the object of the present invention to provide a way of preventing and treating spinal column curvature (scoliosis) in infants.

In accordance with the invention this object is achieved by a child seat device having the features of claim 1 and/or by a child seat having the features of claim 12.

Accordingly there is provided:
a child seat device for a child for aligning the spinal column of the child and for preventing and treating a spinal column curvature of the child, comprising an upper seat part and a lower seat part, wherein the upper seat part is provided with a supporting element on both sides, which supporting elements are designed and arranged relative to the upper seat part in such a way that when a child is sitting on the child seat, the supporting elements surround the ribcage of the child from the rear to the front at the armpit level and thus limit the lateral movements of the child and exert gentle upwardly directed traction, and wherein the child seat device is part of a child car seat or stroller.
a stroller or children's pushchair, in particular a buggy, with a child seat device in accordance with the invention.

The idea forming the basis of the present invention consists of providing a child seat device in which specially provided supporting elements are provided which surround the upper body of the child from the rear to the front at the armpit level and therefore support, fix and align it. The child seat device in accordance with the invention has the particular advantage that the body weight of the child thus comes to rest on the supporting elements. The body of the child is straightened and preferably undergoes a slight pull upwards. At the same time, a lateral movement of the child is limited by the supporting elements. By means of the child seat device in accordance with the invention spinal column curvature is therefore prevented or an existing spinal column curvature is treated.

Advantageous embodiments and developments are apparent from the further subordinate claims and from the description given with reference to the figures of the drawing.

In a particularly advantageous embodiment the supporting elements are height-adjustable and/or laterally adjustable. In this way the supporting elements can very easily be adapted to children of different sizes. By means of the corresponding height adjustment, a desired defined pull is also exerted on the child and in particular on its spinal column so that the child sits in the most upright position possible in the seat without bending to the side. In particular, by means of an appropriate height adjustment, a desired defined pull can be exerted on the child above the child's chest. ‘Upright’ in this context designates a state in which the spinal column is in the S-shape mentioned in the introduction so that as far as possible no lateral bending of the spinal column with simultaneous rotation of the vertebrae occurs.

In a further advantageous embodiment a locking device is provided via which the supporting elements are lockable on their front face, i.e. on the side of the chest of the sitting child. The locking device can, for example, be formed as a belt with a clip fastener, hook-and-loop fastener, buckle or the like. In this way it is possible also to dispense with fixing the child seat device by means of a belt passing through the legs of the child. In addition, the child's comfort is therefore also increased.

In one advantageous embodiment at least one supporting element and preferably both supporting elements are padded. In this way pressure points on the upper body of the child are avoided or at least attenuated.

Similarly in a preferred embodiment at least one supporting element and preferably both supporting elements are formed in an elastic, rounded and/or flattened manner on their upper side against which an arm of the child lies when the device is used as intended. This also means that pressure points on the upper arms of the child are avoided or at least attenuated.

In one advantageous embodiment at least one resilient element is provided via which a supporting element is coupled to the upper seat part in a resilient manner. The resilient element is provided to permit resilient yielding of the supporting element when the supporting element is loaded vertically and/or horizontally. This type of flexible yielding increases comfort for the child sitting in the seat without reducing the functionality thereof with respect to preventing or treating the spinal column curvature.

In one advantageous embodiment the upper seat part and/or the lower seat part are pivotable. The upper seat part and/or the lower seat part are, in particular, lockable at at least one predetermined angle with respect to the lower seat part and the upper seat part respectively. This pivotable function has the advantage that the child seat device can very easily be adapted to the position of a backrest of a stroller, e.g. of a buggy, when the child seat device is disposed or mounted in the stroller.

In a further advantageous embodiment the upper seat part is extendible. In this way, for example, a padded head part attached to the upper seat part can very easily be adapted for children of different sizes and thus the comfort of the child seat device can be increased for the child.

In one advantageous embodiment the child seat device and, in particular, the upper seat part, lower seat part and supporting elements thereof are dimensioned and formed in such a way as to receive an infant, in particular, a child aged from 1 to 3 years.

A particularly advantageous embodiment makes provision that the child seat device is formed as a child car seat for a motor vehicle. The child seat device can be disposed and/or attached as a releasable component in the child car seat or alternatively be formed as an integral component of the child car seat.

An alternative, similarly advantageous embodiment of the stroller in accordance with the invention makes provision for the child seat device to be a fixed, i.e. integral component of the stroller. Alternatively it would also be feasible for the child seat device to be inserted into the stroller as a releasable component and to be releasably attachable via an attachment device, for example, by means of belts, clips and the like, to a frame of the stroller.

In another embodiment in accordance with the invention the upper seat part and/or the lower seat part have at least two longitudinal bearers connected to one another via at least one transverse bearer. In this way a particularly light and inexpensive child seat device can be provided. According to a further embodiment of the invention the upper seat part and the lower seat part are fixedly connected via a common transverse bearer or are pivotably connected about the transverse bearer. Fixed attachment of the upper seat part and of the lower seat part to the common transverse bearer has the advantage that the child seat device is particularly inexpensive to produce. The respective longitudinal bearer of the upper seat part has a first longitudinal bearer part and a second longitudinal bearer part which is displaceably connected to the first longitudinal bearer part. The upper seat part and the lower seat part preferably each have at least one cover or pad.

The embodiments and developments mentioned above can be combined with each other in any sensible manner as desired. Further possible embodiments, developments and implementations of the invention include combinations, even if not specifically mentioned, of features of the invention described above or hereinunder with respect to exemplified embodiments. In particular, the person skilled in the art will also add individual concepts as improvements or additions to the respective basic form of the present invention.

### CONTENTS OF THE DRAWING

The present invention will be explained in more detail hereinunder with the aid of the exemplified embodiments shown in the schematic figures of the drawings in which:

FIG. 1 is a schematic view of an embodiment of a child seat device in accordance with the invention;

FIG. 2 is a perspective view of an embodiment of the child seat device in accordance with the invention;

FIG. 3 is a view of a stroller or children's pushchair with the child seat device in accordance with the invention as shown in FIG. 2;

FIG. 4 is a view of the stroller and of the child seat device of FIG. 3, wherein an infant is firmly buckled in the child seat device.

The enclosed drawings should provide better understanding of the embodiments of the invention. They illustrate embodiments and, in conjunction with the description, serve to clarify principles and concepts of the invention. Other embodiments and many of the stated advantages can be seen in the drawings. The elements of the drawings are not necessarily shown to scale in relation to one another.

In the figures of the drawing like, functionally-like and equivalently acting elements, features and components are each provided with the same reference numerals unless stated otherwise.

### DESCRIPTION OF THE EXEMPLIFIED EMBODIMENTS

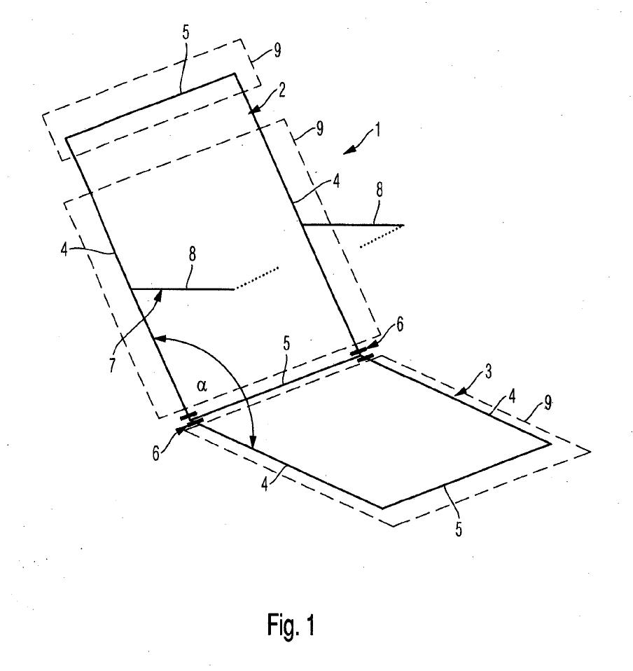

FIG. 1 shows a schematic, greatly simplified illustration of an embodiment of a child seat device 1 in accordance with the invention. The child seat device 1 in this case functions as a therapeutic seat for children to develop a healthy spinal column.

The child seat device 1 in accordance with the invention can, in particular, be used with other seating devices such as e.g. car seats, buggies and other child seats. To this end the child seat device 1 can be integrated in the seat, e.g. the car seat or the seat of the buggy, or be disposed as an insert in the respective seat and selectively additionally be attached thereto.

The child seat device 1 has, as shown in FIG. 1, an upper seat part 2 or back part and a lower seat part 3 or seat part. The upper seat part 2 and the lower seat part 3 can be fixedly connected to one another and form a predetermined, fixedly set angle α to one another. Similarly the upper seat part 2 and the lower seat part 3 can also be pivotably connected to one another in such a way that the angle α between the upper seat part 2 and lower seat part 3 is variably adjustable.

As shown in the exemplified embodiment in FIG. 1, the upper seat part 2 and the lower seat part 3 each have two longitudinal bearers 4. The longitudinal bearers 4 of the upper and lower seat parts 2, 3 are jointly connected to a transverse bearer 5, wherein the upper seat part 2 and/or the lower seat part 3 can pivot about the transverse bearer 5, for example by means of a hinge. The upper seat part 2 and/or the lower seat part 3 forms a hinge 6 with the transverse bearer 5 for pivoting of the upper and/or lower seat part 2, 3. The child seat device 1 is preferably provided with a locking means for locking the upper seat part 2 and the lower seat part 3 at different angles a with respect to one another.

In addition, the longitudinal bearers 5 of the upper seat part 2 and of the lower seat part 3 can each be connected to at least one further transverse bearer 5 for further stabilisation of the upper and lower seat part 2, 3 respectively. For example, a transverse bearer 5 can be provided at an upper end or a head region of the upper seat part 2 and be connected to the two longitudinal bearers 4 of the upper seat part 2. Furthermore, a longitudinal bearer 4 can be provided on the lower end of the lower seat part 3 and the two longitudinal bearers 4 of the lower seat part 3 can be connected to one another.

The two longitudinal bearers 4 of the upper seat part 2 and the two longitudinal bearers 4 of the lower seat part 3 can be fixedly connected to the respective transverse bearer 5, for example, be formed as one piece therewith or be connected by welding or soldering etc to the transverse bearer 5. Similarly the two longitudinal bearers 4 of the upper seat part 2 and lower seat part 3 can also be releasably connected to the associated transverse bearer 5, for example, by screwing and/or pinning.

A supporting device 7 is provided on the upper seat part 2 of the child seat device 1. The supporting device 7 has a respective supporting element 8 on both sides. The supporting element 8 can be fixedly connected to the upper seat part 2 and the longitudinal bearer 4 thereof, for example, it can be formed as one piece with the longitudinal bearer 4 or can be connected thereto by welding or soldering. Similarly the supporting element 8 can also be provided to be displaceable along the longitudinal bearer 4 and therefore to be height-adjustable. The supporting element 8 is preferably formed so that it can be locked or fixed in its respective position on the longitudinal bearer 4 in order to fix it at its set height.

The supporting elements 8 can be attached or locked on the upper seat part 2 at a height such that the supporting elements 8 can surround the upper body of the child from the rear to the front at the armpit level. In this way part of the body weight of the child can come to rest on the supporting elements 8. On the other hand, the child's ability to move laterally can be limited, whereby undesired lateral tilting of the spinal column is prevented. With the supporting elements 8 a slight traction or a slight pull on the upper body of the child can also be produced, with the supporting elements 8 being blocked at a suitable height.

The supporting elements 8 are, as described above, preferably height-adjustable so that they can be adapted to children of different sizes. Similarly the supporting elements 8 can optionally also be extendible (not shown). In addition, the supporting elements 8 are preferably provided with a lockable belt (not shown) on the front face, this belt being able to replace the otherwise present belt connection between the legs of the child.

The supporting elements 8 can be of any form depending on the function and purpose of usage. As shown by the greatly simplified illustration of FIG. 1, the supporting elements 8 can be formed e.g. straight or, for example, curved or angled. As indicated by a dotted line in FIG. 1, the supporting elements 8 can at least partially engage around the body of the child.

As further indicated by a broken line in the schematic illustration in FIG. 1, the child seat device 1 is preferably padded or at least covered with a fabric or overlay. For this purpose the child seat device 1 has padding on the upper seat part 2 and the lower seat part 3 and optionally also padding (not shown) on the lateral supporting elements 8. The padding on the upper seat part 2 can have e.g. a continuous padding part or two separate padding parts 9, i.e. a padding part 9 for the back and a padding part 9 for the head as shown in FIG. 1.

In a further embodiment of the child seat device 1 in accordance with the invention the two longitudinal bearers 4 can each be formed to be extendible. For this purpose the longitudinal bearers 4, are formed, for example, in two parts, wherein a first, lower longitudinal bearer part is formed hollow, for example, to receive and guide a second, upper longitudinal bearer part. The second longitudinal bearer part can also be hollow or can be solid. The second longitudinal bearer part is displaceably disposed in the first longitudinal bearer part and can be blocked or fixed, preferably in different positions, for adjustment of different heights for the padding part for the head. The padding part 9 is connected to the two second longitudinal bearer parts of the longitudinal bearers 4. A transverse bearer 5 can connect the two second longitudinal bearer parts to one another and additionally serve as a handle for pulling out the two second longitudinal bearer parts and therefore for lengthening the longitudinal bearers 4, in a manner comparable to an extendible handle of a suitcase. The padding part 9 for the head is also attached to the two second longitudinal bearer parts and can optionally additionally cover the transverse bearer 5.

The child seat device 1 in accordance with the invention is provided to correct and align the spinal column or backbone and for early treatment of scoliosis or spinal column curvature. Until now these corrections have been carried out two ways. One way of correcting the spinal column is the insertion of an implant in an adult or a child, wherein the child is normally more than 16 years old which means that the formation of the backbone has substantially finished. The surgical intervention required for this purpose cannot be carried out on younger children whose skeleton is still in the active growth phase. A second way of correcting the backbone is the wearing of an orthopaedic brace. Such orthopaedic braces involve external fixing of the ribcage and are consequently primarily directed at ensuring that an existing curvature of the spinal column does not increase further or become more pronounced, but they do not treat the reason for the curvature. The wearing of orthopaedic braces is recommended for children of 13 to 14 years of age. One disadvantage of such an orthopaedic brace, however, is that it limits the function of the musculature of the spinal column, which leads to under-functioning and to atrophy or deterioration of the musculature. Even though the use of an orthopaedic brace constitutes a much less traumatic intervention than the insertion of an implant, the orthopaedic brace is much less effective than an implant.

The disadvantage of both previously mentioned ways of treating a correction of the spinal column is that they cannot be used in the case of small children since at that age the skeleton is still in a very active growth phase. Intervention during this growth process using the two above-mentioned methods can have a lasting detrimental effect on the further development of the spinal column.

In accordance with the invention a child seat device 1 for treating a curvature of the spinal column is therefore provided, which solves the problems outlined above. A correction of the curvature of the spinal column is eminently important since a deformation or curvature of the spinal column in childhood leads to numerous problems in adulthood. The invention thus provides a child seat device 1 which avoids the need for an operation and therefore prevents formation of a spinal column curvature without traumatic intervention. Moreover, the child seat device 1 in accordance with the invention permits correction of an already existing or a developing spinal column curvature or scoliosis in a very early phase, namely in early childhood, i.e. in the range of, for example, 6 to 8 months to 2 to 3 years.

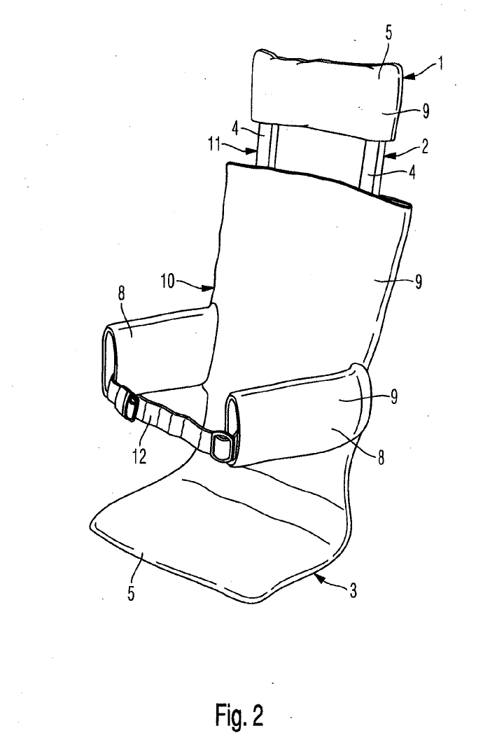

FIG. 2 shows a perspective view of an embodiment of the child seat device 1 in accordance with the invention. The child seat device 1 in accordance with the invention can function as a seat or so-called traction seat which pulls the body of a patient slightly upwards and straightens it. The child seat device 1 has an upper seat part 2 and a lower seat part 3 which each have two longitudinal bearers 4. The upper seat part 2 and the lower seat part 3 are, for example, connected to one another via a common transverse bearer 5, wherein the upper seat part 2 and/or the lower seat part 3 is able to pivot about the transverse bearer 5 so that different angles α can be set between the upper and lower seat part 2, 3. The upper seat part 2 and/or the lower seat part 3 are lockable or fixable at the respectively set angle α.

Furthermore, the two longitudinal bearers 4 of the upper seat part 2 are, for example, also extendible and preferably lockable in the extended position. As previously described in relation to FIG. 1, the respective longitudinal bearer 4 has a first longitudinal bearer part 10 and a second longitudinal bearer part 11, wherein the first or lower longitudinal bearer part 10 is formed hollow, for example, to receive and guide the second or upper longitudinal bearer part 11. The second longitudinal bearer part 11 can likewise be hollow but can also be formed solid. The second longitudinal bearer part 11 is displaceably disposed in the first longitudinal bearer part 10 and can preferably be blocked or fixed in different positions. In this way, for example, different heights can be set for a padding part 9 for the head.

Furthermore, the embodiment of the child seat device 1 shown in FIG. 2 has two supporting elements 8 laterally attached to the longitudinal bearers 4, these supporting elements surrounding the upper body of the child from the rear to the front at the armpit level and therefore limiting its lateral movement and preferably applying a predetermined or defined pull on the child, above the child's chest.

The supporting elements 8 can be formed to be height-adjustable, i.e. adjustable in the vertical direction. For this purpose the supporting elements 8 can be displaceably provided on the longitudinal bearers 4 and can be preferably lockable or fixable at different positions or heights.

Similarly the supporting elements 8 can additionally or alternatively also be adjustable laterally or in the horizontal direction of the child seat device 1. For this purpose the supporting elements 8 can, for example, be extendible and preferably lockable or fixable in the respective extended position.

Furthermore, the supporting elements 8, the upper seat part 2 and the lower seat part 3 can be provided with a soft cover or padding part 9 as shown in the exemplified embodiment in FIG. 2.

The supporting elements 8 are connected to a belt 12 on the front face in order in this way to avoid having a fixing means for the supporting elements 8 between the legs of the child or baby.

The bottom of the lower seat part 3 of the child seat device 1 is flexible and has, for example, padding in order—as far as necessary—to hold the child or baby in a horizontal position without having to remove the supporting elements 8.

The walking of a child in a vertical position is controlled through the human brain, in particular by the so-called cerebellum. For this reason the reflex for the vertical or upright position or the straight posture of the body is controlled through the erector of the spinal column (lat. musculus erector spinae or musculus erector trunci). By reason of the physiological asymmetry of the halves of the brain such muscles also function in an asymmetric manner. Since muscle cramps or muscle spasms are more strongly pronounced on one side, this leads to an inclination of the pelvis to the opposite side. The pelvic tilt is the reason for a shortened right or left leg with the resultant development of lateral curves of the spinal column and a spinal column curvature.

When a child begins to walk, the position of the body step by step is stored—throughout life—in the cerebellum as a so-called false reflex of the vertical position of the body. It has now been discovered that this reflex can be replaced by a physiologically correct reflex. For this purpose, when the child begins to stand and walk independently, a correcting insert or insole is laid under the right or left heel in order to raise the right or left leg accordingly. Constant use of a correcting insert or insole leads to recreation of the symmetrical function of the erector of the spinal column (lat. musculus erector spinae or musculus erector trunci) which consists of a plurality of muscles. This means that no pelvic tilt occurs and it also helps to keep the body in an upright position.

The creation of such a new physiologically correct reflex can, however, be brought about earlier, starting with the creation of this reflex when the parents of the child begin to use a buggy or stroller.

The supporting elements 8 of the child seat device 1 in accordance with the invention which hold the body in an upright position prevent it curving to one side. The body also transmits signals to the cerebellum to store or retain this correct position as a normal or correct physiological reflex. Thus, when the child begins to walk, no pelvic tilt occurs and consequently there is no cause for the formation of curves in the spinal column and a spinal column curvature.

Furthermore, the described child seat device 1 for correction of the spinal column in children can also be used for the same purpose in adults, disabled persons or persons with limited walking capability. Use in a wheelchair would also be feasible. The idea of such correction is founded in a slight pulling effect on the body and minimisation of a lateral movement of the body and prevention of bending of the body to one side by means of the supporting element.

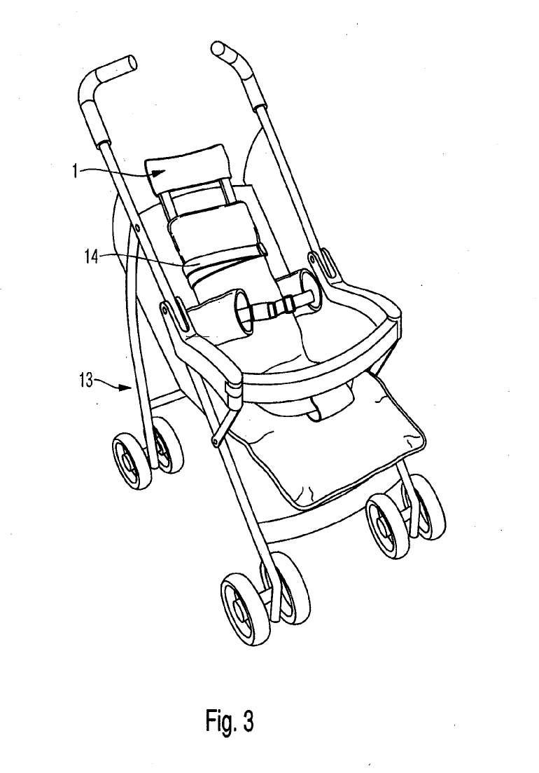

FIG. 3 shows the child seat device 1 of FIG. 2, wherein the child seat device 1 is inserted in a buggy, for example a stroller or children's pushchair 13. In the example shown in FIG. 3, the child seat device 1 can additionally be fixed in the buggy 13 by a belt 14 of the buggy.

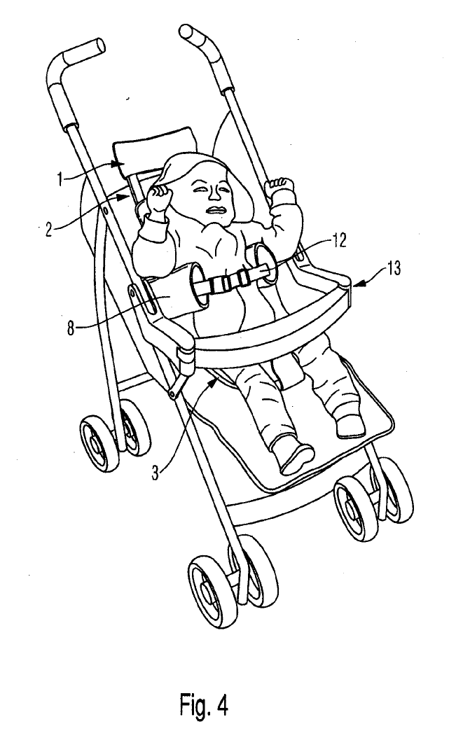

FIG. 4 shows the buggy 13 with the child seat device 1 in accordance with the invention as shown in FIG. 3, with a baby sitting in the child seat device 1. In this case the supporting elements 8 of the child seat device 1 surround the upper body of the child from the rear to the front at the armpit level so that a part of the body weight of the child comes to rest thereon. Furthermore, the supporting elements 8 limit the lateral movement capacity of the upper body. As previously described with reference to FIGS. 1 to 3, the supporting elements 8 can be adjusted laterally and/or in height. Furthermore, the supporting elements 8 are preferably connected on the front face to a lockable belt 12. In the embodiment as an insert into an existing seat, as in this case a seat of a buggy 13, the lower seat part 3 and/or the upper seat part 2 can be pivotable or moveable, for example, by means of a hinge so that when the back rest of the seat of the buggy 13 is adjusted, the inserted seat 1 is adapted accordingly.

Although the present invention has been described fully above with the aid of preferred exemplified embodiments it is not limited thereto but can be modified in numerous ways.

Reference List

1 Child seat device

2 Upper seat part

3 Lower seat part

4 Longitudinal bearer

5 Transverse bearer

6 Hinge

7 Supporting device

8 Supporting element

9 Pad

10 First longitudinal bearer part

11 Second longitudinal bearer part

12 Belt (child seat device)

13 Stroller

14 Belt (stroller)

1-14. (canceled)

15. A child seat device for aligning the spinal column of a child and for preventing and treating a spinal column curvature (scoliosis) of the child, the child seat device comprising:
lower seat part,
an upper seat part,
wherein the upper seat part is provided with a supporting element on both sides, which supporting elements are designed and arranged relative to the upper seat part in such a way that when a child is sitting on the child seat, the supporting elements surround the upper body of the child at the armpit level and thus limit the lateral movements of the child, and
wherein the child seat device is part of a child car seat or a stroller.

16. The device of claim 15, wherein the supporting elements are at least one of height-adjustable and laterally adjustable.

17. The device of claim 15, wherein a locking device is provided via which the supporting elements are lockable on their front face.

18. The device of claim 15, wherein at least one supporting element is padded.

19. The device of claim 15, wherein supporting elements are formed in an elastic, rounded or flattened manner on their upper side against which an arm of the child lies when the device is used as intended.

20. The device of claim 15, wherein at least one resilient element is provided via which a supporting element is coupled to the upper seat part in a resilient manner and which is provided to permit resilient yielding of the supporting element when the supporting element is loaded vertically or horizontally.

21. The device of claim 15, wherein at least one of the upper seat part and the lower seat part are pivotable.

22. The device of claim 21, wherein at least one of the upper seat part and the lower seat part are lockable at at least one predetermined angle with respect to the lower seat part and the upper seat part, respectively.

23. The device of claim 15, wherein the upper seat part is extendible.

24. The device of claim 15, wherein at least one of the child seat device, its upper seat part, its lower seat part and its supporting elements are dimensioned and formed such to receive an infant.

25. The device of claim 15, wherein the child seat device is a child car seat for a motor vehicle and the upper seat part and its supporting elements and the lower seat part are integral components of the child car seat.

26. The device of claim 25, wherein at least one of the upper seat part, its supporting elements and the lower seat part are provided or attached as a releasable component in the child car seat.

27. The device of claim 15, wherein the supporting elements surround the upper body of the child at the armpit level and therefore limit its lateral movements and exert a pull on the child, above the child's chest.

28. A stroller,
having a child seat device for aligning the spinal column of a child and for preventing and treating a spinal column curvature (scoliosis) of the child, the child seat device comprising: lower seat part, an upper seat part, wherein the upper seat part is provided with a supporting element on both sides, which supporting elements are designed and arranged relative to the upper seat part in such a way that when a child is sitting on the child seat, the supporting elements surround the upper body of the child at the armpit level and thus limit the lateral movements of the child, and wherein the child seat device is part of a child car seat or a stroller.

29. The stroller of claim 28, wherein the child seat device is a fixed integral component of the stroller.

30. The stroller of claim 28, wherein the child seat device is provided as a releasable component in the stroller and can be releasably attached to a frame of the stroller by means of an attachment device.

31. The stroller of claim 28, wherein the stroller is a buggy.
